(19) United States
(12) Patent Application Publication
(10) Pub. No.: US 2025/0279521 A1
(43) Pub. Date: Sep. 4, 2025

(54) BATTERY PACK SUPPRESSION SYSTEM

(71) Applicant: Ford Global Technologies, LLC, Dearborn, MI (US)

(72) Inventors: Bhaskara Rao Boddakayala, Troy, MI (US); Di Zhu, Novi, MI (US)

(21) Appl. No.: 18/594,106

(22) Filed: Mar. 4, 2024

(51) Int. Cl. H01M 50/24; H01M 50/249

(52) U.S. Cl. CPC H01M 50/24; H01M 50/249; H01M 2220/20

(57) ABSTRACT

A suppression system for a traction battery pack includes an enclosure, and a battery array within the enclosure. The battery array includes a plurality of battery cells. The suppression system further includes at least one pad within the enclosure. The at least one pad includes one or more combustion suppressing materials.

### TECHNICAL FIELD

This disclosure relates generally to suppression systems for traction battery packs.

### BACKGROUND

A traction battery pack of an electrified vehicle can include groups of battery cells arranged in one or more cell stacks. The traction battery pack includes a plurality of battery cells and various other battery internal components that support electric vehicle propulsion.

### SUMMARY

In some aspects, the techniques described herein relate to a suppression system for a traction battery pack, including: an enclosure; a battery array within the enclosure, the battery array including a plurality of battery cells; and at least one pad within the enclosure, the at least one pad including one or more combustion suppressing materials.

In some aspects, the techniques described herein relate to a suppression system, wherein the at least one pad is at least one foam pad.

In some aspects, the techniques described herein relate to a suppression system, wherein the at least one pad is secured directly to the enclosure.

In some aspects, the techniques described herein relate to a suppression system, wherein the at least one pad includes sodium silicate granules.

In some aspects, the techniques described herein relate to a suppression system, wherein the at least one pad includes aluminum oxide granules.

In some aspects, the techniques described herein relate to a suppression system, wherein the at least one pad includes melamine poly zinc phosphate.

In some aspects, the techniques described herein relate to a suppression system, wherein the at least one pad includes guanidinium nitrate with a copper nitrate oxidizer.

In some aspects, the techniques described herein relate to a suppression system, wherein the at least one pad releases nitrogen gas when in response to thermal energy above a threshold.

In some aspects, the techniques described herein relate to a suppression system, wherein the threshold is 200 degrees Celsius.

In some aspects, the techniques described herein relate to a suppression system, wherein a material composition of the at least one pad includes from 40 to 60 percent sodium silicate, from 10 to 20 percent aluminum oxide, and from 10 to 20 percent melamine poly zinc phosphate.

In some aspects, the techniques described herein relate to a suppression system, wherein the sodium silicate includes a plurality of sodium silicate granules each having a diameter that is from 5 to 100 microns, and the aluminum oxide includes a plurality of aluminum oxide granules each having a diameter that is from 5 to 30 microns.

In some aspects, the techniques described herein relate to a suppression system, wherein the at least one pad is adjacent a plurality of vents from the plurality of battery cells.

In some aspects, the techniques described herein relate to a suppression system, wherein the at least one pad is disposed vertically between the battery array and a cover of the enclosure.

In some aspects, the techniques described herein relate to a suppression system, wherein the at least one pad includes a plurality of endothermic fillers.

In some aspects, the techniques described herein relate to a suppression system, wherein the at least one pad is spaced a distance from the plurality of battery cells in the battery array.

In some aspects, the techniques described herein relate to a suppression system, wherein the at least one pad is secured to a sheet.

In some aspects, the techniques described herein relate to a method of suppression within a traction battery pack, including: in response to a venting event, releasing a combustion suppressant from at least one pad.

In some aspects, the techniques described herein relate to a method, wherein the releasing is in response to a thermal energy level exceeding a threshold level.

In some aspects, the techniques described herein relate to a method, wherein the at least one pad is a foam pad.

In some aspects, the techniques described herein relate to a method, wherein the combustion suppressant is nitrogen.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a perspective view of a traction battery pack from the electrified vehicle of FIG. 1 according to an exemplary embodiment of the present disclosure

FIG. 3 illustrates an expanded, perspective view of the battery pack of FIG. 2.

FIG. 4 is a section view taken at line 4-4 in FIG. 2.

### DETAILED DESCRIPTION

This disclosure details exemplary suppression systems for use in traction battery packs. The suppression system can include a pad that is disposed within an enclosure of the traction battery. The pad can be a foam pad.

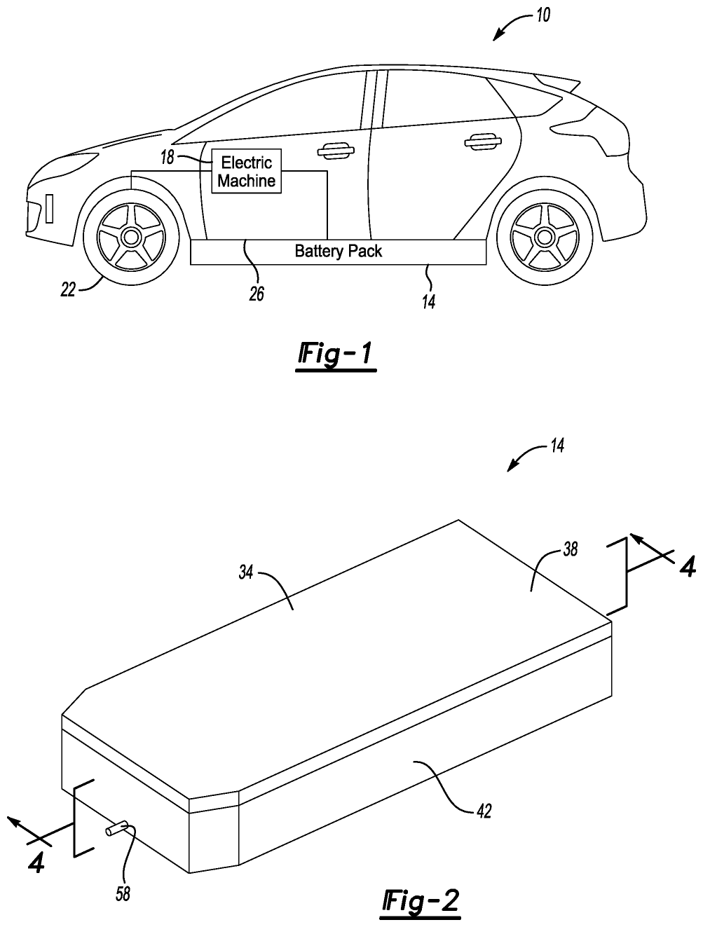

With reference to FIG. 1, an electrified vehicle 10 includes a battery pack 14, an electric machine 18, and wheels 22. The battery pack 14 powers the electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

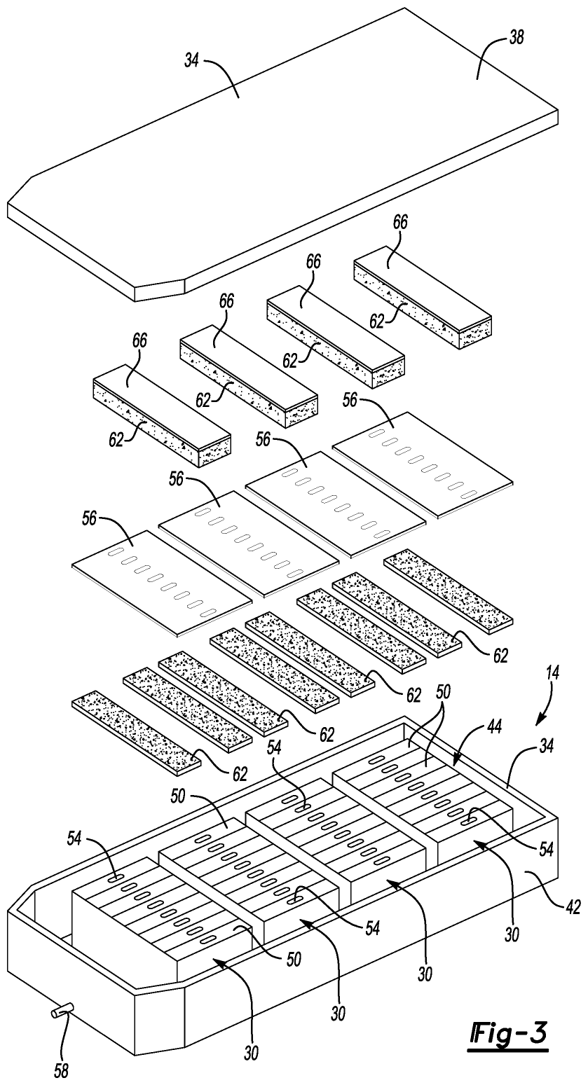

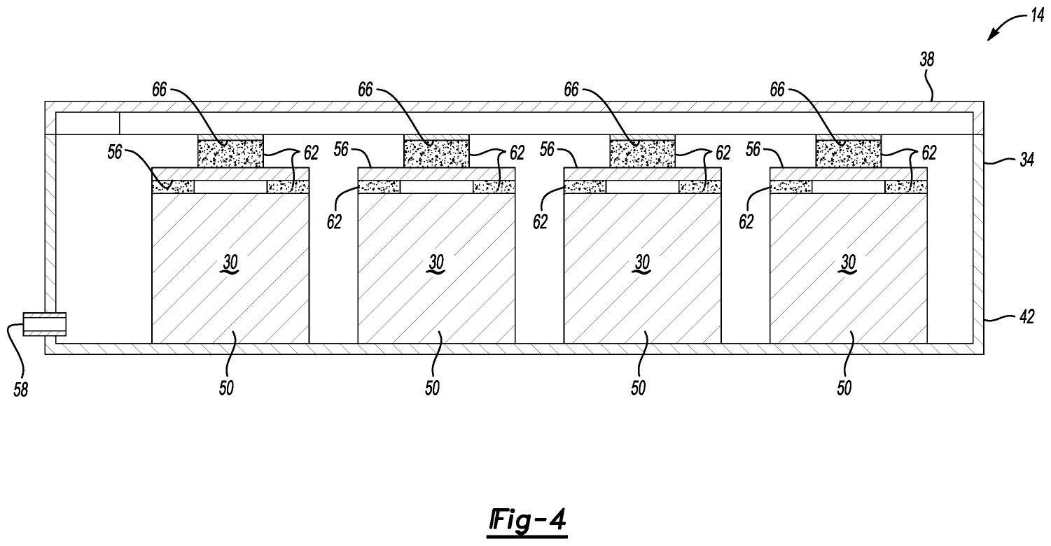

With reference now to FIGS. 2 to 4, the battery pack 14 includes a plurality of battery arrays 30 held within a battery pack enclosure 34. In the exemplary embodiment, the enclosure 34 includes an enclosure cover 38 and an enclosure tray 42. The enclosure cover 38 is secured to the enclosure tray 42 to provide an interior area 44 that houses the battery arrays 30. The enclosure cover 38 can be secured to the enclosure tray 42 using mechanical fasteners (not shown), for example.

Each of the battery arrays 30 includes a plurality of battery cells 50 (or simply, “cells”) stacked side-by-side relative to each other along a respective cell stack axis AA. The battery cells 50 store and supply electrical power. Although specific numbers of the battery arrays 30 and cells 50 are illustrated in the various figures of this disclosure, the battery pack 14 could include any number of the battery arrays 30 having any number of individual cells 50.

In an embodiment, the battery cells 50 are lithium-ion pouch cells. However, battery cells having other geometries (cylindrical, prismatic, etc.) other chemistries (nickel-metal hydride, lead- acid, etc.), or both could alternatively be utilized within the scope of this disclosure.

From time to time, pressure and thermal energy within one or more of the battery cells 50 in the battery pack 14 can increase. This can lead to the battery cells 50 expelling vent byproducts, which can include gas and debris.

The vent byproducts can be expelled from the associated battery cell 50 through a designated vent 54 within the housing of the battery cell 50, such as a membrane that yields in response to increased pressure, or through a ruptured area of the associated battery cell 50. The arrays 30, in this example, include array covers 56 that include openings permitting vent byproducts that have moved through the designated vent 54 into a region of the interior area 44 between the battery arrays 30 and the enclosure cover 38.

The battery pack 14 experiences a venting event when one or more of the battery cells 50 are venting by expelling vent byproducts into the interior area 44 of the enclosure 34. The vent byproducts can move through an enclosure vent 58 when exhausted from the interior area 44.

The battery pack 14 includes at least one pad 62 that includes one or more combustion suppressing materials. In this example, the at least one pad 62 is foam.

The at least one pad 62 can be secured in a plurality of different positions within the interior area 44. In this example, the at least one pad 62 includes pads bonded to an underside of the enclosure cover 38 and other pads sandwiched between the array covers 56 and the battery cells 50. The at least one pad 62 is vertically between the battery arrays 30 and enclosure cover 38 in this example. The at least one pad 62 is adjacent the vents 54 of the battery cells 50. In this example, the at least one pad 62 that is bonded to the underside of the enclosure cover 38 is spaced a distance from all of the battery cells 50.

In this example, the at least one pad 62 that is bonded to the underside of the enclosure cover is secured to a sheet 66, which is then adhesively secured to the underside of the enclosure cover 38 to bond the at least one pad 62 to the enclosure cover 38. The sheet 66 can be, for example, polyethylene terephthalate (PET), polypropylene (PP), polyethylene (PE), or another polymer-based material. In other examples, the at least one pad 62 can be secured directly to the enclosure 34 with an adhesive.

The at least one pad 62 can comprise various types of suppressing materials. As examples, the at least one pad 62 can comprise sodium silicate, aluminum oxide, melamine poly zinc phosphate, guanidinium nitrate, or some combination of these. The at least one pad 62 can include endothermic fillers as combustion suppressing materials. The fillers can be activated when exposed to thermal energy above a threshold.

In an example embodiment, the at least one pad 62 comprises guanidinium nitrate and a copper nitrate oxidizer. When the at least one pad 62 having these materials is exposed to thermal energy associated with vent byproducts, the guanidinium nitrate can decompose into nitrogen gas, water, and carbon, and the copper nitrate oxidizer can reduce a temperature of the vent byproducts.

Some of the suppressing materials can release a combustion suppressant, such as nitrogen. The combustion suppressant is release in response to thermal energy exceeding a threshold, say 200 degrees Celsius. The thermal energy increasing can be due to a release of vent byproducts from one or more of the battery cells 50.

The nitrogen released from the at least one pad 62 reduces oxygen levels within the interior area 44, which can suppress combustion by reducing available oxygen.

The suppressing materials can, in some examples, be part of a foam material composition. In other examples, the suppressing materials can be encapsulated within an outer foam material. Such suppressing materials can be released when the foam material is exposed to relatively high thermal energy levels.

In a specific example, a material composition of the at least one pad 62 comprises from 40 to 60 percent sodium silicate, from 10 to 20 percent aluminum oxide, and from 10 to 20 percent melamine poly zinc phosphate. The sodium silicate can be granular with the granules each having a diameter that is from 5 to 100 microns. The aluminum oxide can comprise a plurality of aluminum oxide granules each having a diameter that is from 5 to 30 microns. Sodium silicate can absorb thermal energy. Aluminum oxide facilitate electrical isolation.

To manage thermal energy within the battery pack, the example suppressants can reduce suppress combustion within a battery pack, inhibit a cascading thermal event, or manage thermal energy in some other way.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A suppression system for a traction battery pack, comprising:
an enclosure;
a battery array within the enclosure, the battery array including a plurality of battery cells; and
at least one pad within the enclosure, the at least one pad including one or more combustion suppressing materials.

2. The suppression system of claim 1, wherein the at least one pad is at least one foam pad.

3. The suppression system of claim 1, wherein the at least one pad is secured directly to the enclosure.

4. The suppression system of claim 1, wherein the at least one pad comprises sodium silicate granules.

5. The suppression system of claim 1, wherein the at least one pad comprises aluminum oxide granules.

6. The suppression system of claim 1, wherein the at least one pad comprises melamine poly zinc phosphate.

7. The suppression system of claim 1, wherein the at least one pad comprises guanidinium nitrate with a copper nitrate oxidizer.

8. The suppression system of claim 1, wherein the at least one pad releases nitrogen gas when in response to thermal energy above a threshold.

9. The suppression system of claim 8, wherein the threshold is 200 degrees Celsius.

10. The suppression system of claim 1, wherein a material composition of the at least one pad comprises from 40 to 60 percent sodium silicate, from 10 to 20 percent aluminum oxide, and from 10 to 20 percent melamine poly zinc phosphate.

11. The suppression system of claim 10, wherein the sodium silicate comprises a plurality of sodium silicate granules each having a diameter that is from 5 to 100 microns, and the aluminum oxide comprises a plurality of aluminum oxide granules each having a diameter that is from 5 to 30 microns.

12. The suppression system of claim 1, wherein the at least one pad is adjacent a plurality of vents from the plurality of battery cells.

13. The suppression system of claim 1, wherein the at least one pad is disposed vertically between the battery array and a cover of the enclosure.

14. The suppression system of claim 1, wherein the at least one pad includes a plurality of endothermic fillers.

15. The suppression system of claim 1, wherein the at least one pad is spaced a distance from the plurality of battery cells in the battery array.

16. The suppression system of claim 1, wherein the at least one pad is secured to a sheet.

17. A method of suppression within a traction battery pack, comprising:
in response to a venting event, releasing a combustion suppressant from at least one pad.

18. The method of claim 17, wherein the releasing is in response to a thermal energy level exceeding a threshold level.

19. The method of claim 17, wherein the at least one pad is a foam pad.

20. The method of claim 17, wherein the combustion suppressant is nitrogen.
